(19) United States
(12) Patent Application Publication
(10) Pub. No.: US 2025/0319925 A1
(43) Pub. Date: Oct. 16, 2025

(54) STEERING APPARATUS FOR VEHICLE

(71) Applicant: HL MANDO CORPORATION, Pyeongtaek-si (KR)

(72) Inventors: Kyungsub SHIN, Pyeongtaek-si (KR); Subong LEE, Pyeongtaek-si (KR); Seunghyun BAE, Pyeongtaek-si (KR)

(73) Assignee: HL MANDO CORPORATION, Pyeongtaek-si (KR)

(21) Appl. No.: 19/092,418

(22) Filed: Mar. 27, 2025

(30) Foreign Application Priority Data
Apr. 12, 2024 (KR) 10-2024-0049568

(51) Int. Cl. B62D 5/04; B62D 7/22

(52) U.S. Cl. CPC B62D 5/0403; B62D 7/22

(57) ABSTRACT

The present embodiments provide a steering apparatus including an actuator rod having a fastening hole provided on one side of an outer surface and axially sliding, a rod fastening member having one end coupled with a magnet assembly and the other end coupled to the fastening hole, a rod housing having a rod hole through which the actuator rod slides and an accommodation hole communicating with the rod hole provided on one side of an outer surface, a pair of support members that support both inner sides of the accommodation hole and are coupled to slide axially together with the actuator rod and are separately arranged on both radial sides of the rod fastening member, and an elastic member coupled to an outer surface of the rod fastening member and elastically supporting the pair of support members.

### CROSS REFERENCE TO RELATED APPLICATION

This application claims priority from Korean Patent Application No. 10-2024-0049568, filed on Apr. 12, 2024, which is hereby incorporated by reference for all purposes as if fully set forth herein.

### BACKGROUND

### Technical Field

Embodiments of the present disclosure relate to a steering apparatus for a vehicle. More specifically, embodiments of the present disclosure relate to a steering apparatus for a vehicle capable of improving durability by accurately measuring changes in axial displacement of an actuator rod to increase the precision of steering angle measurement, and minimizing noise and vibration and maintaining the precision of steering angle measurement even after the shock and vibration are transmitted from a road surface.

### Description of the Related Art

In general, the steering apparatus of a vehicle is equipped with a hydraulic device, motor, or reducer to steer the wheels of the vehicle according to the driving conditions of the vehicle, and it is usually operated on the rear wheels of a general vehicle or the front and rear wheels of a steer-by-wire system.

In the steering apparatus of a vehicle, the axial movement of an actuator rod is measured by a sensor that detects the movement of a magnet. The sensor may measure the displacement of an object that moves in a linear reciprocating motion, and an electronic control device may stably control the steering of the vehicle based on the sensor information.

However, the steering apparatus of the vehicle may have a problem in that the steering apparatus cannot accurately measure the change in axial displacement of the actuator rod due to reasons such as the mounting structure of the magnet, sensor, and peripheral components, so that the measurement accuracy of the steering angle is lowered.

In addition, the noise and vibration may increase and the measurement accuracy of the steering angle may be drastically reduced after the period in which the shock and vibration transmitted from the road surface while driving the automobile continues. Therefore, it is required a manner for improving durability of the steering apparatus.

### BRIEF SUMMARY

Embodiments of the present disclosure relate to a vehicular steering apparatus device that can improve durability by accurately measuring the change in axial displacement of the actuator rod to increase the precision of steering angle measurement and minimizing noise and vibration while maintaining the precision of steering angle measurement even after the shock and vibration are transmitted from the road surface for a long period of time.

In accordance with embodiments of the present disclosure, there may be provided a steering apparatus including an actuator rod having a fastening hole provided on one side of an outer surface and axially sliding, a rod fastening member having one end coupled with a magnet assembly and the other end coupled to the fastening hole, a rod housing having a rod hole through which the actuator rod slides and an accommodation hole communicating with the rod hole provided on one side of an outer surface, a pair of support members that support both inner sides of the accommodation hole and are coupled to slide axially together with the actuator rod and are separately arranged on both radial sides of the rod fastening member, and an elastic member coupled to an outer surface of the rod fastening member and elastically supporting the pair of support members.

In accordance with embodiments of the present disclosure, there may be provided a steering apparatus including an actuator rod having a fastening hole provided on one side of an outer surface and axially sliding, a rod fastening member having one end coupled with a magnet assembly and the other end coupled to the fastening hole, a rod housing having a rod hole through which the actuator rod slides, and an accommodation hole communicating with the rod hole provided on one side of an outer surface that, a pair of support members that support both inner sides of the accommodation hole and are coupled to slide axially together with the actuator rod and are separately arranged on both radial sides of the rod fastening member, and an elastic support member coupled to the inner surface of the pair of support members and elastically supporting the rod fastening member.

According to embodiments of the present disclosure, it is possible to provide a steering apparatus of a vehicle capable of improving the durability by accurately measuring the change in axial displacement of the actuator rod to increase the precision of steering angle measurement and minimizing noise and vibration while maintaining the precision of steering angle measurement even after the shock and vibration are transmitted from the road surface for a long period of time.

### BRIEF DESCRIPTION OF THE SEVERAL VIEWS OF THE DRAWINGS

FIG. 1 and FIG. 2 are perspective views illustrating a steering apparatus of a vehicle according to the embodiments.

FIG. 3 is an exploded perspective view illustrating a steering apparatus of a vehicle according to the embodiments.

FIG. 4 is a perspective view illustrating a steering apparatus of a vehicle according to the embodiments.

FIG. 5 and FIG. 6 are exploded perspective views illustrating a steering apparatus of a vehicle according to the embodiments.

FIG. 7 is a front view illustrating a steering apparatus of a vehicle according to the embodiments.

FIG. 8 and FIG. 9 are cross-sectional views illustrating a steering apparatus of a vehicle according to the embodiments.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including,” “having,” “containing,” “constituting” “make up of,” and “formed of” used herein are generally intended to allow other components to be added unless the terms are used with the term “only.” As used herein, singular forms are intended to include plural forms unless the context clearly indicates otherwise.

Terms, such as “first, “second,” “A,” “B,” “(A),” or “(B)” may be used herein to describe elements of the disclosure. Each of these terms is not used to define essence, order, sequence, or number of elements, etc., but is used merely to distinguish the corresponding element from other elements.

When it is mentioned that a first element “is connected or coupled to,” “contacts or overlaps,” etc., a second element, it should be interpreted that, not only can the first element “be directly connected or coupled to” or “directly contact or overlap” the second element, but a third element can also be “interposed” between the first and second elements, or the first and second elements can “be connected or coupled to,” “contact or overlap,” etc., each other via a fourth element. Here, the second element may be included in at least one of two or more elements that “are connected or coupled to,” “contact or overlap,” etc., each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

The shapes, sizes, dimensions (e.g., length, width, height, thickness, radius, diameter, area, etc.), ratios, angles, number of elements, and the like illustrated in the accompanying drawings for describing the embodiments of the present disclosure are merely examples, and the present disclosure is not limited thereto.

A dimension including size and a thickness of each component illustrated in the drawing are illustrated for convenience of description, and the present disclosure is not limited to the size and the thickness of the component illustrated, but it is to be noted that the relative dimensions including the relative size, location, and thickness of the components illustrated in various drawings submitted herewith are part of the present disclosure.

In addition, when any dimensions, relative sizes, etc., are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

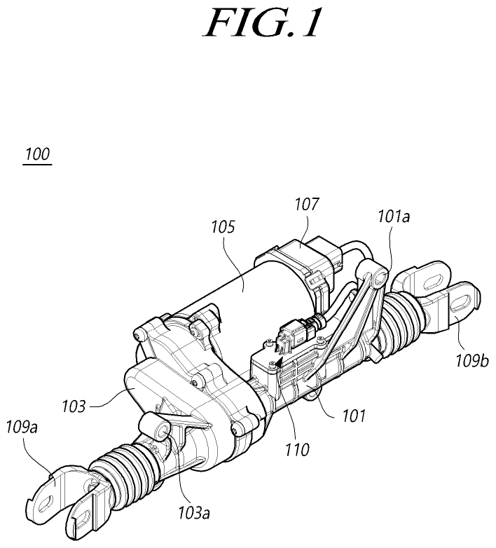

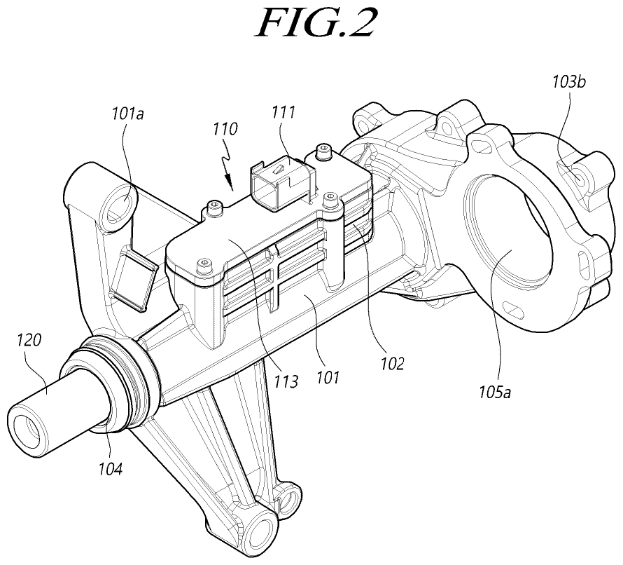

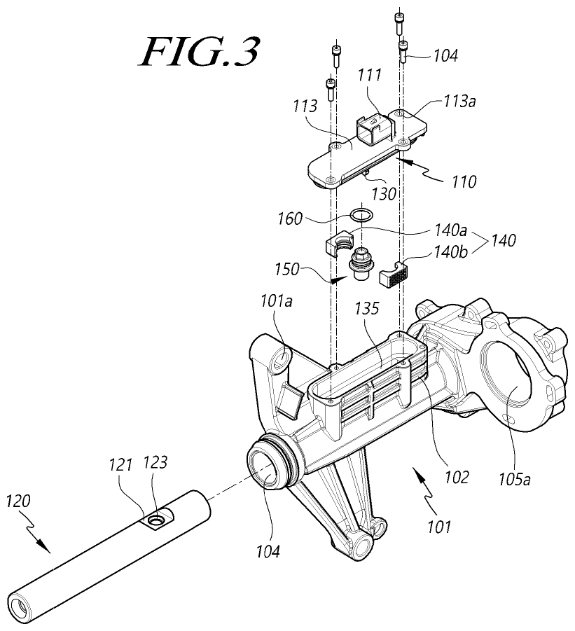

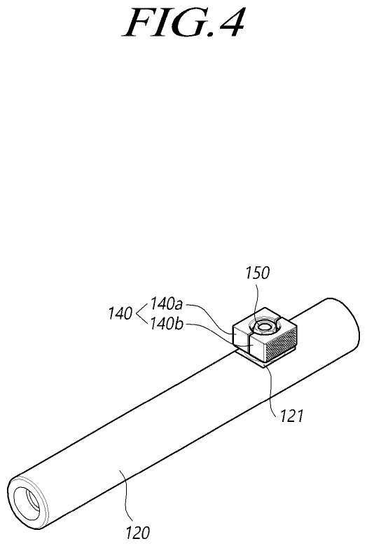

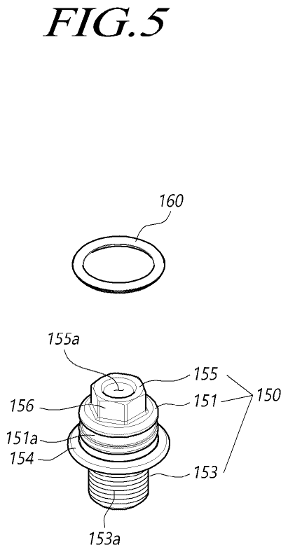

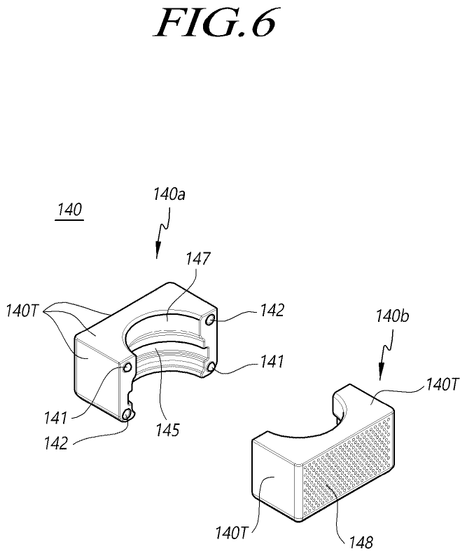

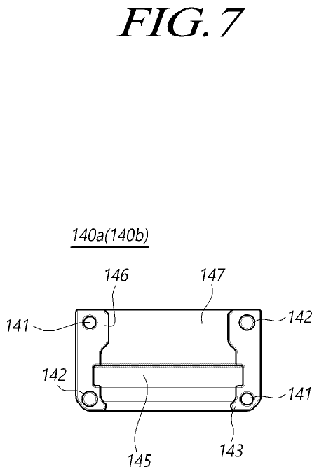

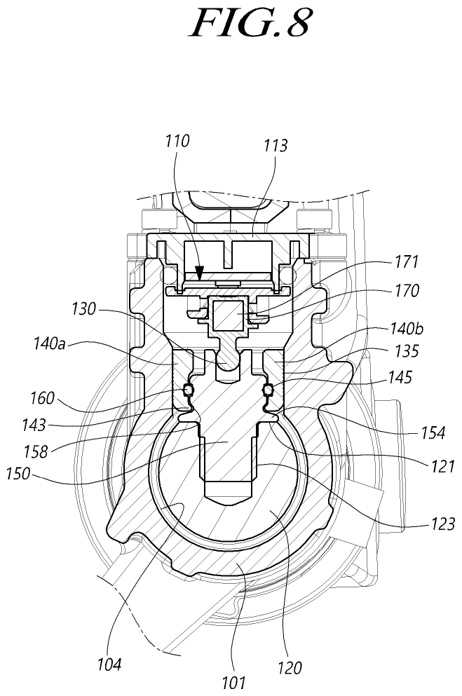

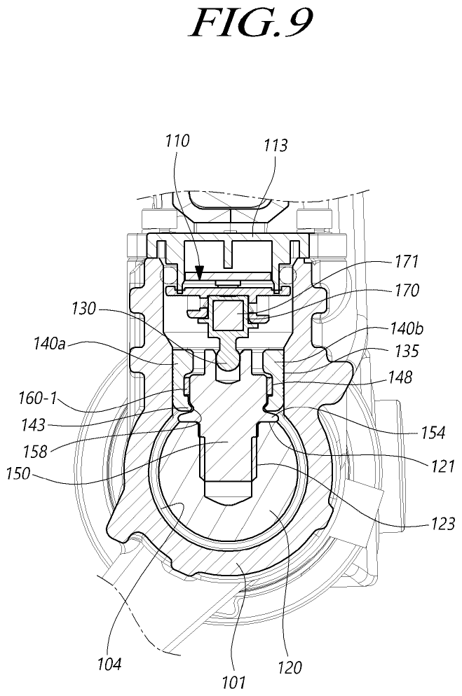

FIG. 1 and FIG. 2 are perspective views illustrating a steering apparatus of a vehicle according to the embodiments, FIG. 3 is an exploded perspective view illustrating a steering apparatus of a vehicle according to the embodiments, FIG. 4 is a perspective view illustrating a steering apparatus of a vehicle according to the embodiments, FIG. 5 and FIG. 6 are exploded perspective views illustrating a steering apparatus of a vehicle according to the embodiments, FIG. 7 is a front view illustrating a steering apparatus of a vehicle according to the embodiments, and FIG. 8 and FIG. 9 are cross-sectional views illustrating a steering apparatus of a vehicle according to the embodiments.

First, referring to FIG. 1 to FIG. 8, a steering apparatus 100 of a vehicle according to present embodiments includes an actuator rod 120 having a fastening hole 123 provided on one side of an outer surface and axially sliding, a rod fastening member 150 having one end coupled with a magnet assembly 170 and the other end coupled to the fastening hole 123, a rod housing 101 having a rod hole 104 through which the actuator rod 120 slides and an accommodation hole 135 communicating with the rod hole 104 provided on one side of an outer surface, a pair of support members 140 that support both inner sides of the accommodation hole 135 and are coupled to slide axially together with the actuator rod 120 and are separately arranged on both radial sides of the rod fastening member 150, and an elastic member 160 coupled to an outer surface of the rod fastening member 150 and elastically supporting the pair of support members 140.

In the steering apparatus 100 according to present embodiments, the actuator rod 120 performs steering of the vehicle while performing linear sliding motion in the axial direction, and a sensor assembly 110 detects the change in the magnetic field of a magnet 171 built into the magnet assembly 170 that performs linear sliding motion together with the actuator rod 120 and transmits information on the change in axial displacement to an electronic control device 107 to calculate a steering angle.

The actuator rod 120 is built into the inside of the rod housing 101 and moves linearly in the axial direction. The rod fastening member 150 and the support member 140 are connected to the actuator rod 120 and slide axially together with the actuator rod 120 inside the rod housing 101.

The actuator rod 120 may be screw-connected to a ball nut (not shown) and may slide axially through a belt (not shown) transmitting the driving force of a motor 105. The electronic control device 107 may control the operation of the motor 105 by calculating the steering angle through the change in the magnetic field of the magnet 171 detected by the sensor assembly 110.

The motor 105, the belt, the ball nut may be built into a drive housing 103 that is coupled to one side of the rod housing 101, and a detailed description of these built-in parts will be omitted.

The rod housing 101 and the drive housing 103 are provided with wheel connection brackets 109a and 109b that are coupled to a road wheel, and body fixing holes 101a and 103a for fixing to the body of the vehicle.

A flat surface 121 formed by cutting a flat surface is provided on one side of the outer surface of the actuator rod 120, and the fastening hole 123 is provided in the flat surface 121 to couple the rod fastening member 150.

Therefore, during the actuator rod 120 slides, the rod fastening member 150 may maintain the exact sliding direction at the exact position of the actuator rod 120.

As shown in FIGS. 3 and 4, the rod fastening member 150 is coupled with the magnet assembly 170 at the upper end and coupled with the actuator rod 120 at the lower end, and slides axially together with the actuator rod 120.

As shown in FIG. 3, the rod housing 101 is provided with a rod hole 104 through which the actuator rod 120 slides, and is provided with the accommodation hole 135 on one side of the outer surface that is open upward and communicates with the rod hole 104.

The rod housing 101 has a box-shaped protruding receiving portion 102 formed on one side, and the accommodation hole 135 is provided in the inner space of the receiving portion 102.

Therefore, when the actuator rod 120 slides, the sensor assembly 110 can stably detect the change in the magnetic field of the magnet 171 at the closest position.

The support member 140 may be formed as a pair that is separated and arranged on both radial sides of the rod fastening member 150, and may support the inner sides of the accommodation hole 135, and may be coupled to slide in the axial direction together with the actuator rod 120.

In addition, the elastic member 160 coupled to the outer surface of the rod fastening member 150 elastically supports the support member 140 to the inner sides of the accommodation hole 135.

The elastic member 160 formed in a ring shape may be formed of one or more materials selected from the group consisting of NR (Natural Rubber), NBR (Nitrile Butadiene Rubber), CR (Chloroprene Rubber), EPDM (Ethylene Propylene Terpolymer), FPM (Fluoro Rubber), SBR (Styrene Butadine Rubber), CSM (Chlorosulphonated Polyethylene), PU (Polyurethane), and silicone rubber.

Therefore, since the elastic member 160 continuously elastically supports the support member 140 on both inner sides of the accommodation hole 135, noise and vibration caused by the clearance between the support member 140 and the accommodation hole 135 may be prevented, and the accuracy of sliding position detection can be increased.

In the present embodiments, the elastic member 160 may be formed of NBR (Nitrile Butadiene Rubber) which has excellent oil resistance, oxidation resistance, ozone resistance, and weather resistance.

As shown in FIG. 5, the support member 140 may include a first support member 140a and a second support member 140b which are formed symmetrically and separately, and a coupling projection 141 may be provided on one side of the facing surfaces of the first support member 140a and the second support member 140b and a coupling groove 142 coupled with the coupling projection 141 may be provided on the other side, or a coupling groove 142 may be provided on one side of the facing surfaces and a coupling projection 141 coupled with the coupling groove 142 may be provided on the other side.

The coupling projection 141 and the coupling groove 142 may set the coupling position of the first support member 140a and the second support member 140b during assembly, and at the same time, may prevent displacement due to the elastic force of the elastic member 160 when the actuator rod 120 slides, and maintain the correct position.

The support member 140 may be formed of one or more materials selected from the group consisting of polyacetal (POM), polyamide (PA), polycarbonate (PC), polyimide (PI), polybutylene terephthalate (PBT), polyphenylene sulfide (PPS), and phenol formaldehyde (PF), and may be formed by mixing 20 to 60 wt % of glass fiber.

Therefore, the support member 140 can have a predetermined elasticity and wear resistance, thereby absorbing vibration and impact noise generated during operation and minimizing the amount of wear.

In addition, the support member 140 may be provided with a coating layer 140T coated with a polytetrafluoroethylene (PTFE) material on the outer surface.

The support member 140 may be provided with a support grooves 148 formed to be sunken or recessed on the outer side surface supported on both sides of the inner side of the accommodation hole 135 of the rod housing 101, and the support grooves 148 may be provided in a plurality of numbers while being spaced apart from each other.

In addition, the support grooves 148 may be filled with a lubricant to minimize friction with the inner side surface of the accommodation hole 135 of the rod housing 101 when the support member 140 slides in the axial direction. To further elaborate, when the inside of the support grooves 148 is filled with the lubricant, this does not imply a narrow interpretation of the support grooves 148 being “filled” exclusively with the lubricant to the exclusion of other materials. Namely, the term “filled with,” as used herein, is intended to encompass a broad range of conditions, including but not limited to “partially filled with,” “substantially filled with,” “completely filled with,” or “exclusively filled with.”

Referring to FIG. 5 to FIG. 8 together, the rod fastening member 150 may include a body part 151 having a fixing projection on the outer surface 154 that protrudes radially and is fastened to the flat surface 121, a screw fastening part 153 that is arranged on the lower side of the fixing projection 154 and has a screw portion 153a formed on the outer surface to be coupled to the fastening hole 123, and a head part 155 that is arranged on the upper side of the body part 151 and has a tool fastening surface 156 formed on the outer surface.

A reduced diameter portion 158 is provided on the upper side of the fixing projection 154 formed from the outer surface of the body part 151, and an insertion projection 143 that is inserted into the reduced diameter portion 158 may be provided on the lower side of the support member 140.

In addition, an outer groove 151a to which an elastic member 160 is coupled may be provided on the outer surface of the body part 151, and an inner groove 145 may be provided on the inner peripheral surface of the support member 140 in which an elastic member 160 is inserted and supported at a position facing the outer groove 151a.

In addition, referring to FIG. 6 and FIG. 7 together, a small diameter portion 146 formed to protrude toward the head part 155 of the rod fastening member 150 is provided on the upper end of the support member 140, and a head receiving space 147 for receiving the head part 155 is provided on the inner side of the small diameter portion 146, so that the support member 140 can maintain its position without being displaced in the upper and lower direction of the rod fastening member 150.

The magnet assembly 170 is supported and connected to the upper end of the rod fastening member 150, and a magnet 171 is built into the inner side of the magnet assembly 170, so that the sensor assembly 110 can detect the change in axial displacement of the actuator rod 120 due to the change in the magnetic field when the actuator rod 120 slides in the axial direction.

The rod fastening member 150 is provided with an insertion support groove 155a at the upper end of the head part 155, and a insertion support portion 130 of the magnet assembly 170 is inserted into the insertion support groove 155a, so that the magnet assembly 170 can slide in the axial direction together with the support member 140.

In addition, the upper part of the magnet assembly 170 is provided with a sensor cover 113 and a sensor assembly 110 that are fixed to the upper opening of the accommodation hole 135.

The sensor cover 113 is provided with a housing fastening hole 113a so that sensor cover 113 is connected to the upper part of the opening of the rod housing 101 by a fastening member 104 and protects the internal electrical components of the sensor assembly 110.

A connection terminal 111 that electrically connects to an electronic control device 107 is provided on one side of the upper part of the sensor cover 113.

In addition, referring to FIG. 9 together with FIG. 1 to FIG. 7, a steering apparatus of a vehicle according to the present embodiments may include an actuator rod 120 having a fastening hole 123 provided on one side of an outer surface and axially sliding, a rod fastening member 150 having one end coupled with a magnet assembly 170 and the other end coupled to the fastening hole 123, a rod housing 101 having a rod hole 104 through which the actuator rod 120 slides, and an accommodation hole 135 communicating with the rod hole 104 provided on one side of an outer surface, a pair of support members 140 that support both inner sides of the accommodation hole 135 and are coupled to slide axially together with the actuator rod 120 and are separately arranged on both radial sides of the rod fastening member 150, and an elastic support member 160-1 coupled to the inner surface of the pair of support members 140 and elastically supporting the rod fastening member 150.

Here, the actuator rod 120 and the rod housing 101, the magnet assembly 170, and a sensor assembly 110 are the same as those illustrated in the aforementioned FIGS. 1 to 8, so detailed descriptions thereof are omitted.

The support member 140 is formed as a pair separated and arranged on both radial sides of the rod fastening member 150, and is supported on both inner sides of the accommodation hole 135 to slide axially together with the actuator rod 120.

The inner circumference of the support member 140 may be provided with a fixing groove 148 into which an elastic support member 160-1 is inserted and fixed.

The elastic support member 160-1 formed in an arc shape may be formed of one or more materials selected from the group consisting of NR (Natural Rubber), NBR (Nitrile Butadiene Rubber), CR (Chloroprene Rubber), EPDM (Ethylene Propylene Terpolymer), FPM (Fluoro Rubber), SBR (Styrene Butadine Rubber), CSM (Chlorosulphonated Polyethylene), PU (Polyurethane), and Silicone rubber.

the present embodiments, the elastic support member 160-1 may be formed of NBR (Nitrile Butadiene Rubber) which has oil resistance and oxidation resistance, ozone resistance, and weather resistance characteristics.

The support member 140 includes a first support member 140a and a second support member 140b that are formed symmetrically and separately, and a coupling projection 141 may be provided on one side of the facing surfaces of the first support member 140a and the second support member 140b and a coupling groove 142 coupled with the coupling projection 141 may be provided on the other side, or a coupling groove 142 may be provided on one side of the facing surfaces and a coupling projection 141 coupled with the coupling groove 142 may be provided on the other side.

The support member 140 may be formed of one or more materials selected from the group consisting of polyacetal (POM), polyamide (PA), polycarbonate (PC), polyimide (PI), polybutylene terephthalate (PBT), polyphenylene sulfide (PPS), and phenol formaldehyde (PF), and may be formed by mixing 20 to 60 wt % of glass fiber.

In addition, the support member 140 may be provided with a coating layer 140T coated with polytetrafluoroethylene (PTFE) material on the outer surface.

The support member 140 may be provided with a support groove 148 formed to be sunken or recessed on the outer surface supported on both inner sides of the accommodation hole 135 of the rod housing 101, and the support grooves 148 may be provided in multiple numbers spaced apart from each other.

In addition, a lubricant may be filled in the support groove 148 to minimize friction with the inner surface of the accommodation hole 135 of the rod housing 101 when the support member 140 slides in the axial direction.

The magnet assembly 170 is supported and connected to the upper end of the rod fastening member 150, and a magnet 171 is built into the inner side of the magnet assembly 170, so that the sensor assembly 110 can detect the change in axial displacement of the actuator rod 120 due to the change in the magnetic field when the actuator rod 120 slides in the axial direction.

The rod fastening member 150 is provided with an insertion support groove 155a at the upper part of the head part 155, and an insertion support portion 130 of the magnet assembly 170 is inserted into the insertion support groove 155a, so that the magnet assembly 170 slides in the axial direction together with the support member 140.

In addition, the upper part of the magnet assembly is provided with a sensor cover 113 and a sensor assembly 110 that are fixed to the upper opening of the accommodation hole 135.

The rod fastening member 150 may include a body part 151 having a fixing projection 154 on the outer surface that protrudes radially and is fixed to the flat surface 121, a screw fastening part 153 that is arranged on the lower side of the fixing projection 154 and is coupled to the fastening hole 123, and a head part 155 that is arranged on the upper side of the body part 151 and has a tool fastening surface 156 on the outer surface.

A reduced diameter portion having a diameter reduced from the outer surface of the body part 151 may be provided on the upper side of the fixing protrusion 154, and an insertion protrusion 143 inserted into the reduced diameter portion 158 may be provided on the lower side of the support member 140.

According to the present embodiments having such a structure and shape, it is possible to provide a steering apparatus of a vehicle capable of improving the durability by accurately measuring the change in axial displacement of the actuator rod to increase the precision of steering angle measurement and minimizing noise and vibration while maintaining the precision of steering angle measurement even after the shock and vibration are transmitted from the road surface for a long period of time.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

The scope of protection of the present disclosure should be interpreted by the claims below, and all technical ideas within the scope equivalent thereto should be interpreted as being included in the scope of the present disclosure.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A steering apparatus comprising:
an actuator rod having a fastening hole provided on one side of an outer surface and axially sliding;
a rod fastening member having one end coupled with a magnet assembly and the other end coupled to the fastening hole;
a rod housing having a rod hole through which the actuator rod slides, and an accommodation hole communicating with the rod hole provided on one side of an outer surface;
a pair of support members that support both inner sides of the accommodation hole and are coupled to slide axially together with the actuator rod and are separately arranged on both radial sides of the rod fastening member; and
an elastic member coupled to an outer surface of the rod fastening member and elastically supporting the pair of support members.

2. The steering apparatus of claim 1, wherein a flat surface is provided on one side of the outer surface of the actuator rod, and the fastening hole is provided on the flat surface.

3. The steering apparatus of claim 1, wherein the pair of support members includes a first support member and a second support member that are formed symmetrically and separately,
wherein the steering apparatus further comprises:
a coupling projection provided on one side of facing surfaces of the first support member and the second support member, and
a coupling groove coupled with the coupling projection being provided on the other side of the facing surfaces.

4. The steering apparatus of claim 1, wherein the pair of support members includes one or more materials selected from the group consisting of polyacetal (POM), polyamide (PA), polycarbonate (PC), polyimide (PI), polybutylene terephthalate (PBT), polyphenylene sulfide (PPS), and phenol formaldehyde (PF).

5. The steering apparatus of claim 4, wherein the pair of support members include 20 to 60 weight percent of glass fiber.

6. The steering apparatus of claim 5, wherein the pair of support members include a coating layer formed of polytetrafluoroethylene (PTFE) material on an outer surface.

7. The steering apparatus of claim 1, wherein the pair of support members are provided with support grooves formed to be recessed in an outer surface and are supported on both inner surfaces of the accommodation hole.

8. The steering apparatus of claim 7, wherein the support grooves are provided in a plurality of numbers and are spaced apart from each other.

9. The steering apparatus of claim 8, wherein the support grooves have lubricant therein.

10. The steering apparatus of claim 2, wherein the rod fastening member comprises:
a body part having a fixing projection that radially protrudes and is fixed to the flat surface on an outer surface;
a screw fastening part arranged on one side of the fixing projection and coupled to the fastening hole; and
a head part arranged on one side of the body part and having a tool fastening surface on an outer surface.

11. The steering apparatus of claim 10, wherein one side of the fixing projection includes a reduced diameter portion from an outer surface of the body part, and
wherein one side of the pair of support members includes an insertion projection to be inserted into the reduced diameter portion.

12. The steering apparatus of claim 10, wherein the body part is provided with an outer groove to which the elastic member is joined on an outer surface.

13. The steering apparatus of claim 12, wherein each of the pair of support members includes an inner groove on an inner surface, in which the elastic member is inserted and supported at a position facing the outer groove.

14. A steering apparatus comprising:
an actuator rod having a fastening hole provided on one side of an outer surface and axially sliding;
a rod fastening member having one end coupled with a magnet assembly and the other end coupled to the fastening hole;
a rod housing having a rod hole through which the actuator rod slides, and an accommodation hole communicating with the rod hole provided on one side of an outer surface;
a pair of support members that support both inner sides of the accommodation hole and are coupled to slide axially together with the actuator rod and are separately arranged on both radial sides of the rod fastening member; and
an elastic support member coupled to the inner surface of the pair of support members and elastically supporting the rod fastening member.

15. The steering apparatus of claim 14, wherein a flat surface is provided on one side of the outer surface of the actuator rod, and the fastening hole is provided on the flat surface.

16. The steering apparatus of claim 15, wherein the rod fastening member comprises:
a body part having a fixing projection that radially protrudes and is fixed to the flat surface on an outer surface;
a screw fastening part arranged on one side of the fixing projection and coupled to the fastening hole; and
a head part arranged on one side of the body part and having a tool fastening surface on an outer surface.

17. The steering apparatus of claim 16, wherein an upper side of the fixing projection includes a reduced diameter portion from an outer surface of the body part, and
wherein a lower side of the pair of support members includes an insertion projection inserted into the reduced diameter portion.

18. The steering apparatus of claim 16, wherein the pair of support members include a fixing groove in an inner surface into which the elastic support member is inserted and fixed.

19. The steering apparatus of claim 14, wherein the pair of support members includes a first support member and a second support member that are formed symmetrically and separately,
wherein the steering apparatus further comprises:
a coupling projection provided on one side of facing surfaces of the first support member and the second support member, and
a coupling groove coupled with the coupling projection being provided on the other side of the facing surfaces.

20. The steering apparatus of claim 14, wherein the pair of support members are provided with support grooves formed to be recessed in an outer surface and are supported on both inner surfaces of the accommodation hole, and
wherein the support grooves are provided in a plurality of numbers and are spaced apart from each other.
